(19) United States
(12) Patent Application Publication
(10) Pub. No.: US 2025/0021523 A1
(43) Pub. Date: Jan. 16, 2025

(54) REMOTE PREFETCH

(71) Applicant: VAST DATA LTD., Tel Aviv (IL)

(72) Inventors: Or Dahan, Tel Aviv (IL); Yogev Vaknin, Tel Aviv (IL); Alon Berger, Tel Aviv (IL); Lior Klipper, Tel Aviv (IL); Doron Hogery, Tel Aviv (IL); Uri Weissbrem, Tel Aviv (IL)

(73) Assignee: VAST DATA LTD., Tel Aviv (IL)

(21) Appl. No.: 18/349,939

(22) Filed: Jul. 10, 2023

(51) Int. Cl. G06F 16/172; G06F 16/11

(52) U.S. Cl. CPC G06F 16/172; G06F 16/122

(57) ABSTRACT

A method for responding to access requests, the method may include (a) detecting, by a controller of a local storage system (LSS), a read pattern that (i) is associated with a requestor that is in communication with the LSS, and (ii) is estimated to comprise future read requests that are aimed to a remote part of a file system entity (FSE) that is stored at a remote storage system (RSS); wherein there is a latency difference between a remote latency associated with the remote part of the FSE and a LSS latency that is associated with the requestor; and (b) performing a prefetch process of remote sub-parts of the remote part of the FSE in order to support the read pattern while maintaining a desired latency.

### BACKGROUND

A global file system is a distributed file system that can be accessed from multiple geographic locations, across a wide-area network, and enables concurrent access to a global namespace that enterprises and branch offices can access data from anywhere.

Prefetch is a process where stored content is prepared for fast access, based on the assumption that the content will likely be requested, enabling the content to be read instantly if and when the user requests it. The content is read into the cache in the background, for anticipated future use without the user making an explicit request for it.

There is a need to prefetch the content of a global filesystem entity that is spread across storage systems at different geographic locations.

### SUMMARY

There may be provided a method for remote prefetch.

### BRIEF DESCRIPTION OF THE DRAWINGS

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings in which:

FIG. 1 is an example of a group of three storage systems and a user computer;

FIG. 2 is an example of a group of four storage systems and a user computer:

FIG. 3 is an example of a group of two storage systems and a user computer; and

FIG. 4 is an example of a method.

### DETAILED DESCRIPTION OF THE DRAWINGS

Any reference to “may be” should also refer to “may not be”.

In the following detailed description, numerous specific details are set forth in order to provide a thorough understanding of the one or more embodiments of the disclosure. However, it will be understood by those skilled in the art that the present one or more embodiments of the disclosure may be practiced without these specific details. In other instances, well-known methods, procedures, and components have not been described in detail so as not to obscure the present one or more embodiments of the disclosure.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

Because the illustrated embodiments of the disclosure may for the most part, be implemented using electronic components and circuits known to those skilled in the art, details will not be explained in any greater extent than that considered necessary as illustrated above, for the understanding and appreciation of the underlying concepts of the present one or more embodiments of the disclosure and in order not to obfuscate or distract from the teachings of the present one or more embodiments of the disclosure.

Any reference in the specification to a method should be applied mutatis mutandis to a system capable of executing the method and should be applied mutatis mutandis to a non-transitory computer readable medium that stores instructions that once executed by a computer result in the execution of the method.

Any reference in the specification to a system and any other component should be applied mutatis mutandis to a method that may be executed by a system and should be applied mutatis mutandis to a non-transitory computer readable medium that stores instructions that may be executed by the system.

Any reference in the specification to a non-transitory computer readable medium should be applied mutatis mutandis to a system capable of executing the instructions stored in the non-transitory computer readable medium and should be applied mutatis mutandis to method that may be executed by a computer that reads the instructions stored in the non-transitory computer readable medium.

Any combination of any module or unit listed in any of the figures, any part of the specification and/or any claims may be provided. Especially any combination of any claimed feature may be provided.

The group of storage systems of the present invention enables users to access content that is defined as globally shared content, that is stored in any of the storage systems. The user may not be aware of the location of the content that is requested to be read, and the content of a single stored entity (file, object, database table, snapshot) may be split among different remote storage systems. The user may be connected to one of the storage systems, that is responsible for providing the content requested by the user, whether the content is stored in the directly connected storage system, or at least part or all of the content is stored in one or more remote storage system.

The storage systems of a group of storage systems may be located at different geographic locations and may be connected via various networks and at different distances from each other, therefore resulting different latencies when accessing contents stored at different storage systems. When serving an access request that requires accessing a remote storage system, most of the latency of the response is due to the bi-directional traversal of network: of the request towards the target storage system and the respond back towards the requesting storage system that is coupled to the requesting user.

It is desirable that a user that reads from a certain file system entity (FSE, e.g., file, object, database table, snapshot, directory, etc.) will experience the same latency as the average latency of local reads, regardless of the location of the FSE.

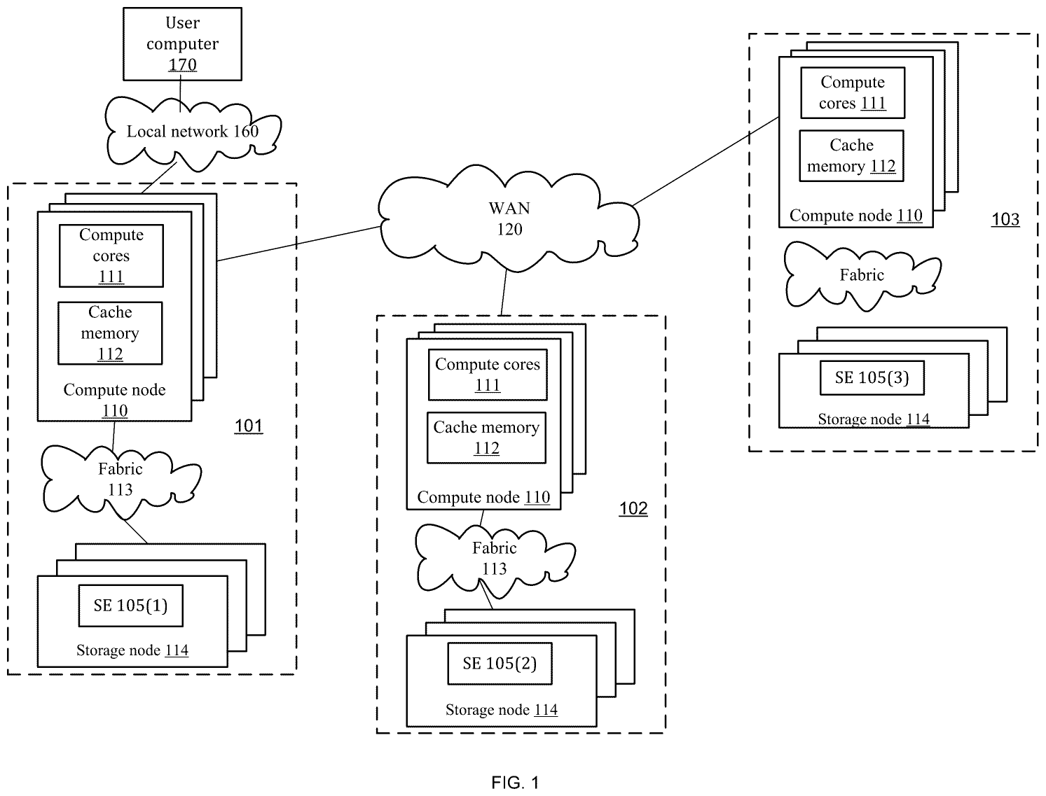

FIG. 1 illustrates a group of three storage systems 101-103 and a user computer 170 that is coupled to first storage system 101 via a local network 160. Each storage system is composed of one or more compute nodes, wherein each compute node may include one or more compute cores that implement the logic of the methods described herein. The compute nodes are coupled via a fabric 113 to one or more storage nodes 114 that includes storage devices that store one or more stored entities (that may be part of a filesystem, a database, an object store, etc.), and particularly, global FSEs, whose content can be spread among any of the storage systems 101-103.

The storage systems (or the compute nodes 110 of the storage systems) can communicate with each other via one or more Wide-Area-Network (WAN) 120, for obtaining content that is stored in other storage systems.

FIG. 1 further illustrates a FSE 105, where one part 105(1) is stored in a storage node 114 of the first storage system 101, a second part 105(2) is stored in a storage node 114 of the second storage system 102, and a third part 105(3) is stored in a storage node 114 of the third storage system.

When user computer 170 sends read requests to its directly connected storage system 101 for reading FSE 105(1), which is locally stored at the storage node 14 of storage system 101, it experiences a certain latency of the responses that is relatively small, given that the communication path of the request and the response includes only the local network 160 and fabric 113, which provides a relatively fast communication path. The latency may be improved if the read FSE, e.g., FSE 105(1) is prefetched into the cache memory 112 (e.g., RAM—Random Access Memory) of storage system 101, and read from the cache memory 112 in response to requests.

When user computer 170 sends read requests to its directly connected storage system 101 for reading parts of FSE 105 that are stored remotely, e.g., part FSE 105(2), which is remotely stored at the storage node of storage system 102, the responses to these requests experience a much higher latency, given that the communication path of the request and the response includes, in addition to local network 160, the crossing via WAN 120, since storage system 101 needs to request the content of FSE 105(2) from storage system 102 and to receive the content via WAN 120. The latency when accessing FSEs via the WAN may be hundred times (or more) larger than the local latency.

According to embodiments of the invention, each storage system monitors the local average latency of read requests directed to local content that resides on the storage nodes or the cache memory of the storage system, and further monitors over-the-WAN latencies towards each of the other storage systems.

Each storage system further monitors read accesses for detecting access patterns, such as, but not limited to sequential read accesses.

A storage system can detect a certain read pattern, where the anticipated future reads are to be directed to a part of a FSE that resides on a remote storage system, which may happen either because the reads that were already performed and detected as a pattern are already directed to a remote storage system, or because the pattern implies that though the detected reads are local reads, the predicted upcoming requests will be directed to offsets (parts) of the FSE that are stored at a remote storage system. The detected reads of the pattern may be directed to one of the remote storage systems and the predicted upcoming requests may be directed to a part of the FSE that are stored at another remote storage system.

Upon detecting a read pattern, where future accesses are expected to be directed towards a remote content, a dual-tier prefetch is performed, blocks that are expected to be read next are prefetched from the remote storage system into the cache of the local storage system, and blocks, expected to be read following the cached blocks, are read into the storage devices of the local storage node.

A first number of data blocks, that are expected to be accessed next (following the reads in the detected pattern), are read ahead into the cache memory of the local storage system that serves the access toward the requested FSE, and is directly connected to the requesting user. The first number is a number of data blocks that should always be maintained in the cache memory and ready to be read, so as to avoid variants in the latencies caused by fetching from a remote storage system. In order to secure the presence of the first number in the cache memory as long as parts of the requested FSE are being read, a second number of data blocks that are expected to be read following reading the first number of blocks, are read ahead into the storage nodes of the storage system that serves the access toward the requested FSE.

The second number of data blocks is determined based on the measured local latency and the measured remote latency related to the remote storage system that stores the part of the FSE that is being prefetched. The second number of data blocks may be based on the ratio between the measured remote latency and the measured local latency. For example, if the average remote latency of the round trip to and from the remote storage system is 100 ms and the average local latency of reading from the local storage nodes is Ims, then 100 blocks (100 ms/1 ms) will be read from the remote system into the storage nodes of the storage system that serves the access request.

The local latency also dictates the highest rate of read requests that can be received from the user, though the user may send read requests at a lower rate. The detecting of the read pattern may further detect the read rate, and the determining of the second number may further take into account the read rate.

Each time the user performs the next read request for a remote block that is cached locally, the next expected block is read from the storage node into the cache, and a remote request is initiated for fetching the next block (that follows the last remote block that is stored in the local storage system) into the storage nodes of the local storage system.

Suppose the local latency of local reads is measured, by storage system 101, as 1 millisecond, the remote latency of reading by storage system 101 from storage system 102 is 100 msec, and the remote latency of reading by storage system 101 from storage system 103 is 200 msec. Suppose a sequential read pattern is detected by storage system 101 from user computer 170, for accessing FSE 105, starting from the first block. Suppose part 105(1) includes blocks 1-300, part 105(2) that is stored at storage system 102 includes blocks 301-600, and blocks 601 and above are stored at storage system 103.

When the sequential read is detected, the time when the read requests will be directed to remotely stored content at another storage system, can be calculated (or—how many reads until a receiving a read request that will be directed to a remote system), and based on the second number of blocks that should be read ahead, the timing of requesting the second number of blocks can be determined.

For example, suppose that after reading the first 100 blocks that reside on storage system 101, a sequential pattern of reading the first blocks is detected. It can also be detected that if the read sequence dictated by the pattern continues, then—after 300 blocks, the read requests will be directed to content that is stored at storage system 102. Since the user read requests experience a latency of 1 millisecond, which also dictates the maximum rate of receiving the read requests, the timing of needing to request the remote blocks can be determined to be after local reading of 200 blocks, when there are 100 blocks left to be locally read (which takes Ims*100), and wherein reading 100 remote blocks is expected to be 100 milliseconds, which is similar to the time it takes to read from storage system 102, knowing the latency against this storage system is 100 msec.

When the sequential pattern is continued after switching to reading from storage system 102, the timing of switching to prefetching blocks from storage system 103 can be detected in a similar manner, and according to the measured latency against storage system 103, which is 200 msec, and therefore requires prefetching the next blocks from storage system 103 after reading the first 100 blocks from storage system 102, when there are 200 blocks left to be read from this system, which is expected to take 200*1 msec.

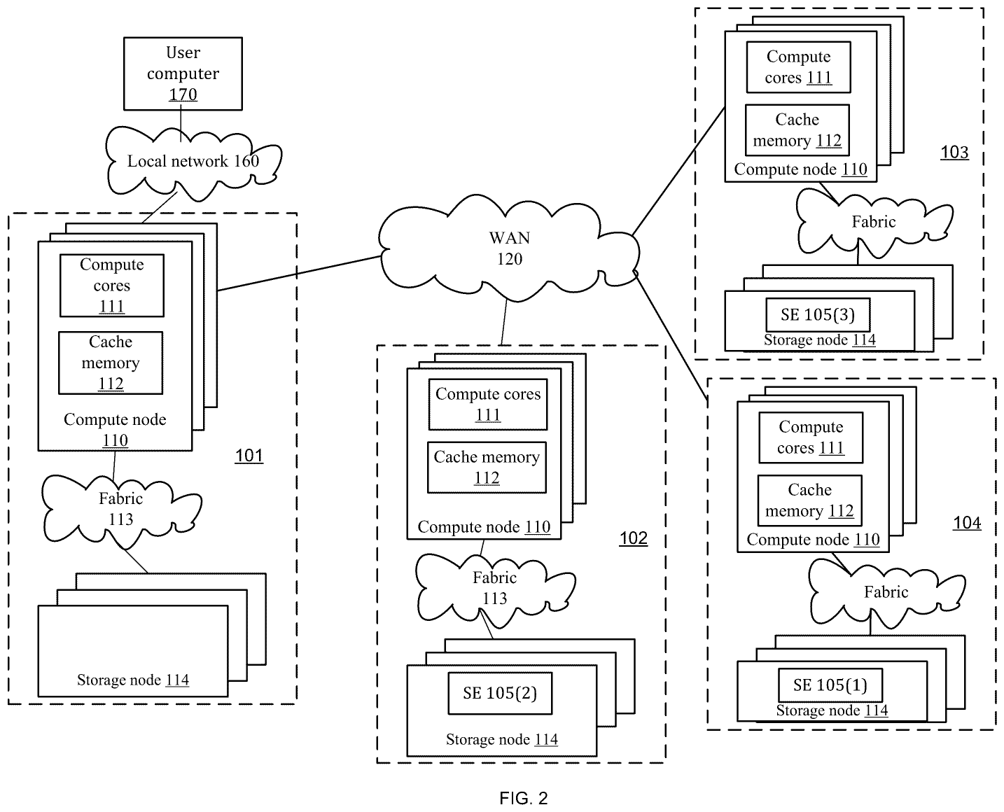

In FIG. 1 the first storage system 101 was the local storage system and it also stores the first part of the FSE. It should be noted that the local storage may not store (at a given point of time) any part of the FSE—as illustrated in FIG. 2.

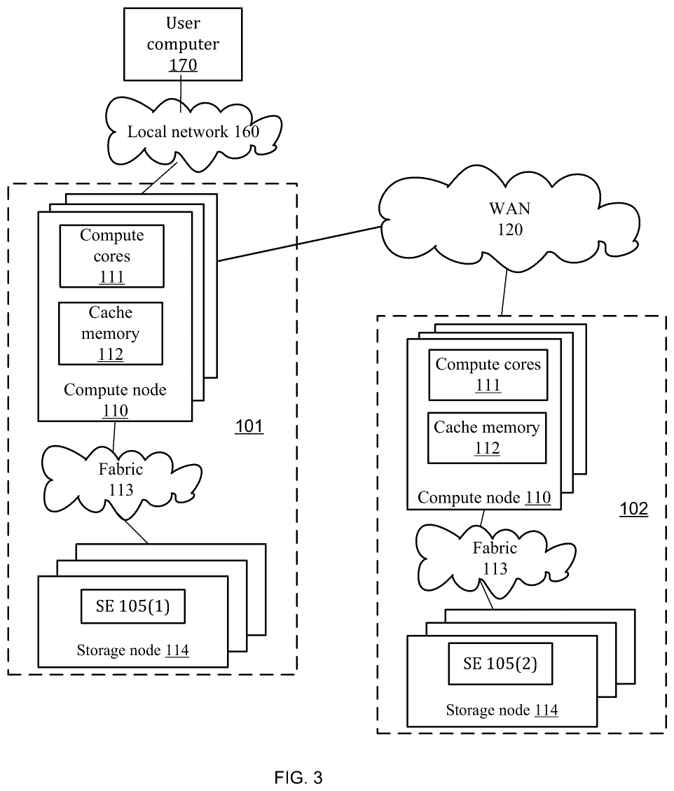

In FIG. 1 there are three storage systems that store three different parts of an FSE. There may be any number of storage systems and any number of different FSE parts. An FSE may store a part of an FSE or may not store a part of the FSE. For example—FIG. 3 illustrates only two storage systems.

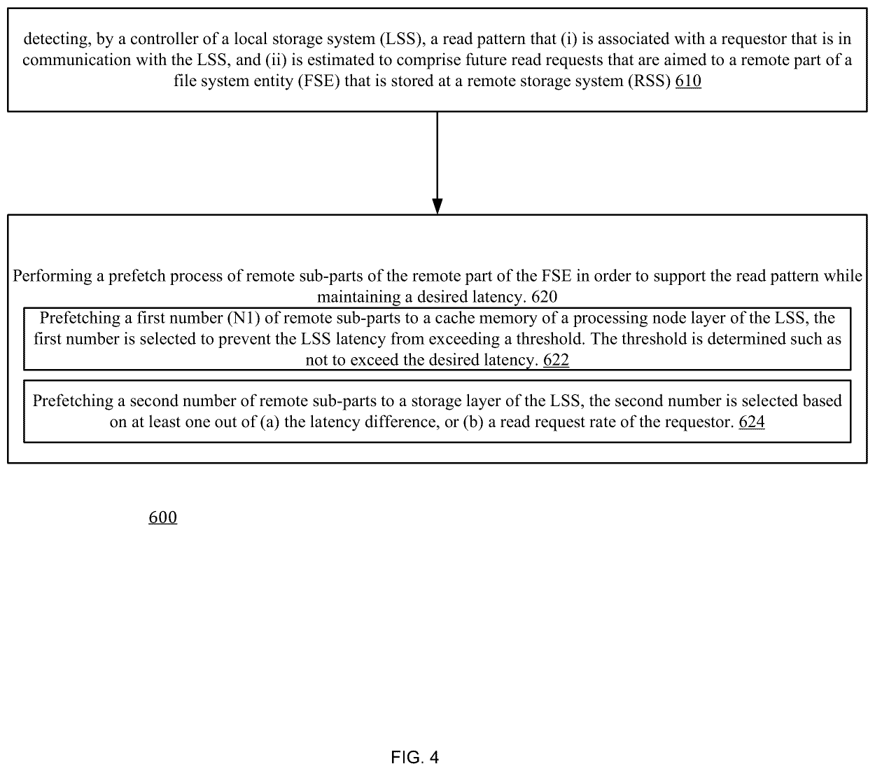

FIG. 4 illustrates an example of a method 600 for responding to access requests.

According to an embodiment, method 600 starts by step 610 of detecting, by a controller of a local storage system (LSS), a read pattern that (i) is associated with a requestor that is in communication with the LSS, and (ii) is estimated to comprise future read requests that are aimed to a remote part of a file system entity (FSE) that is stored at a remote storage system (RSS). In FIG. 1 the LSS is the first storage system 101. The remote storage system may be any storage system of second, third or fourth storage systems 102, 103 or 104 respectively. The requestor may be a user computer or application that uses the storage services provided by or via the LSS. The controller may be one or more of the compute cores 111 of the LSS, or part of a compute core, which is a processing circuitry that may be implemented as a central processing unit (CPU), and/or one or more other integrated circuits such as application-specific integrated circuits (ASICs), field programmable gate arrays (FPGAs), full-custom integrated circuits, etc., or a combination of such integrated circuits. The read pattern may be further associated with the FSE or with other FSEs related to the FSE (e.g., files that are always read one after the other).

There is a latency difference between a remote latency associated with the remote part of the FSE and a LSS latency that is associated with the requestor. The remote latency is based, at least in part, on the time it takes for responding to read requests of a certain size, when the requested content is read from the remote system. The LSS latency is based, at least in part, on the time it takes for responding to read requests received from the requestor and served from content stored at the LSS.

According to an embodiment, step 610 is followed by step 620 of performing a prefetch process of remote sub-parts of the remote part of the FSE in order to support the read pattern while maintaining a desired latency. Supporting the read pattern may include selecting the remote sub-parts so as to continue the read pattern that was detected.

According to an embodiment, step 620 includes steps 622 and 624.

Step 622 includes prefetching a first number (N1) of remote sub-parts to a cache memory of a processing node layer of the LSS, the first number is selected to prevent the LSS latency from exceeding a threshold. The threshold is determined such as not to exceed the desired latency.

Step 624 includes prefetching a second number of remote sub-parts to a storage layer of the LSS, the second number is selected based on at least one out of (a) the latency difference, or (b) a read request rate of the requestor. The second number may be selected based on a ratio between the remote latency and the LSS latency. The storage layer may include the storage nodes 114.

According to an embodiment, the remote latency exceeds the LSS latency by a factor of at least ten.

According to an embodiment, step 620 includes maintaining, as long as remote-sub-parts are expected to be read, at least the first number of remote sub-parts in the cache memory. The maintaining may include copying a remote sub-part that is stored in the LSS's storage layer into the cache memory of the LSS. When copying a remote sub-part into the cache, at least one subsequent sub-part is read from the RSS into the LSS's storage layer.

According to an embodiment, step 620 includes maintaining, as long as the remote-sub-parts are expected to be read, at least the second number of remote sub-parts in the storage layer.

According to an embodiment, the desired latency does not exceed the LSS latency.

Step 610 may include detecting that the read pattern is estimated to include local read requests aimed to a local part of the FSE that is stored in the LSS. Step 620 may include pre-fetching local sub-parts of the local part of the FSE in order to support the read pattern while maintaining the desired latency.

While steps 610 and 620 were described in relation to a single remote storage system—method 600 may be executed for two or more remote storage systems.

For example—step 610 may include detecting, by the controller, a further read pattern that is associated with the requestor and is estimated to comprise further future read requests that are aimed to a further remote part of the FSE that is stored at a further remote storage system (FSS): wherein there is a further latency difference between a further latency associated with the further remote part of the FSE and the LSS latency. Step 620 may include performing a further prefetch process of further remote sub-parts of the further remote part of the FSE in order to support the further read pattern while maintaining the desired latency.

In this case, step 620 may include prefetching the first number of further remote sub-parts to the cache memory of the processing node layer of the LSS, and prefetching a third number of further remote sub-parts to the storage layer of the LSS, the third number is selected based on at least one out of (a) the further latency difference, or (b) a read request rate of the requestor. The third number may differ from the second number or may equal the second number.

In the foregoing specification, the invention has been described with reference to specific examples of embodiments of the invention. It will, however, be evident that various modifications and changes may be made therein without departing from the broader spirit and scope of the invention as set forth in the appended claims.

Those skilled in the art will recognize that the boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely exemplary, and that in fact many other architectures may be implemented which achieve the same functionality.

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Any reference to “consisting”, “having” and/or “including” should be applied mutatis mutandis to “consisting” and/or “consisting essentially of”.

Furthermore, those skilled in the art will recognize that boundaries between the above described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It is appreciated that various features of the embodiments of the disclosure which are, for clarity, described in the contexts of separate embodiments may also be provided in combination in a single embodiment. Conversely, various features of the embodiments of the disclosure which are, for brevity, described in the context of a single embodiment may also be provided separately or in any suitable sub-combination.

It will be appreciated by persons skilled in the art that the embodiments of the disclosure are not limited by what has been particularly shown and described hereinabove. Rather the scope of the embodiments of the disclosure is defined by the appended claims and equivalents thereof.

We claim:

1. A method for responding to access requests, the method comprising:
detecting, by a controller of a local storage system (LSS), a read pattern that (i) is associated with a requestor that is in communication with the LSS, and (ii) is estimated to comprise future read requests that are aimed to a remote part of a file system entity (FSE) that is stored at a remote storage system (RSS); wherein there is a latency difference between a remote latency associated with the remote part of the FSE and a LSS latency that is associated with the requestor; and
performing a prefetch process of remote sub-parts of the remote part of the FSE in order to support the read pattern while maintaining a desired latency: wherein the performing of the prefetch process comprises:
prefetching a first number of remote sub-parts to a cache memory of a processing node layer of the LSS, the first number is selected to prevent the LSS latency from exceeding a threshold, and
prefetching a second number of remote sub-parts to a storage layer of the LSS, the second number is selected based on at least one out of (a) the latency difference, or (b) a read request rate of the requestor.

2. The method according to claim 1, wherein the remote latency exceeds the LSS latency by a factor of at least ten.

3. The method according to claim 1, comprising maintaining, as long as further remote sub-parts are expected to be read, at least the first number of remote sub-parts in the cache memory.

4. The method according to claim 2, comprising maintaining, as long as the further remote-sub-parts are expected to be read, at least the second number of remote sub-parts in the storage layer.

5. The method according to claim 1, wherein the desired latency does not exceed the LSS latency.

6. The method according to claim 1 wherein the read pattern is estimated to comprise local read requests aimed to a local part of the FSE that is stored in the LSS; wherein the performing of the prefetch process comprises pre-fetching local sub-parts of the local part of the FSE in order to support the read pattern while maintaining the desired latency.

7. The method according to claim 1, comprising:
detecting, by the controller, a further read pattern that is associated with the requestor and is estimated to comprise further future read requests that are aimed to a further remote part of the FSE that is stored at a further remote storage system (FSS); wherein there is a further latency difference between a further latency associated with the further remote part of the FSE and the LSS latency; and
performing a further prefetch process of further remote sub-parts of the further remote part of the FSE in order to support the further read pattern while maintaining the desired latency.

8. The method according to claim 7, wherein the performing of the prefetch process comprises prefetching the first number of further remote sub-parts to the cache memory of the processing node layer of the LSS, and prefetching a third number of further remote sub-parts to the storage layer of the LSS, the third number is selected based on at least one out of (a) the further latency difference, or (b) a read request rate of the requestor.

9. A non-transitory computer readable medium for responding to access requests, the non-transitory computer readable medium stores instructions for:
detecting, by a controller of a local storage system (LSS), a read pattern that (i) is associated with a requestor that is in communication with the LSS, and (ii) is estimated to comprise future read requests that are aimed to a remote part of a file system entity (FSE) that is stored at a remote storage system (RSS); wherein there is a latency difference between a remote latency associated with the remote part of the FSE and a LSS latency that is associated with the requestor; and
performing a prefetch process of remote sub-parts of the remote part of the FSE in order to support the read pattern while maintaining a desired latency; wherein the performing of the prefetch process comprises:
prefetching a first number of remote sub-parts to a cache memory of a processing node layer of the LSS, the first number is selected to prevent the LSS latency from exceeding a threshold, and
prefetching a second number of remote sub-parts to a storage layer of the LSS, the second number is selected based on at least one out of (a) the latency difference, or (b) a read request rate of the requestor.

10. The non-transitory computer readable medium according to claim 9, wherein the remote latency exceeds the LSS latency by a factor of at least ten.

11. The non-transitory computer readable medium according to claim 9, that stores instructions for maintaining, as long as further remote-sub-parts are expected to be read, at least the first number of remote sub-parts in the cache memory.

12. The non-transitory computer readable medium according to claim 11, that stores instructions for maintaining, as long as the further remote-sub-parts are expected to be read, at least the second number of remote sub-parts in the storage layer.

13. The non-transitory computer readable medium according to claim 9, wherein the desired latency does not exceed the LSS latency.

14. The non-transitory computer readable medium according to claim 9, wherein the read pattern is estimated to comprise local read requests aimed to a local part of the FSE that is stored in the LSS: wherein the performing of the prefetch process comprises pre-fetching local sub-parts of the local part of the FSE in order to support the read pattern while maintaining the desired latency.

15. The non-transitory computer readable medium according to claim 9, that stores instructions for:
detecting, by the controller, a further read pattern that is associated with the requestor and is estimated to comprise further future read requests that are aimed to a further remote part of the FSE that is stored at a further remote storage system (FSS): wherein there is a further latency difference between a further latency associated with the further remote part of the FSE and the LSS latency; and
performing a further prefetch process of further remote sub-parts of the further remote part of the FSE in order to support the further read pattern while maintaining the desired latency.

16. The non-transitory computer readable medium according to claim 15, wherein the performing of the prefetch process comprises prefetching the first number of further remote sub-parts to the cache memory of the processing node layer of the LSS, and prefetching a third number of further remote sub-parts to the storage layer of the LSS, the third number is selected based on at least one out of (a) the further latency difference, or (b) a read request rate of the requestor.

17. A local storage system (LSS), comprising:
a processing node layer of the LSS, the processing node comprising a cache memory;
a storage layer; and
a controller that is configured to:
detect, a read pattern that (i) is associated with a requestor that is in communication with the LSS, and (ii) is estimated to comprise future read requests that are aimed to a remote part of a file system entity (FSE) that is stored at a remote storage system (RSS); wherein there is a latency difference between a remote latency associated with the remote part of the FSE and a LSS latency that is associated with the requestor; and
control a performing a prefetch process of remote sub-parts of the remote part of the FSE in order to support the read pattern while maintaining a desired latency; wherein the performing of the prefetch process comprises:
prefetching a first number of remote sub-parts to the cache memory, the first number is selected to prevent the LSS latency from exceeding a threshold, and
prefetching a second number of remote sub-parts to the storage layer, the second number is selected based on at least one out of (a) the latency difference, or (b) a read request rate of the requestor.
